(19) United States
(12) Patent Application Publication
(10) Pub. No.: US 2020/0383527 A1
(43) Pub. Date: Dec. 10, 2020

(54) Shower Wine Glass Holder with Speaker

(71) Applicant: Jack Mosseri, New York, NY (US)

(72) Inventor: Jack Mosseri, New York, NY (US)

(21) Appl. No.: 16/927,733

(22) Filed: Jul. 13, 2020

Related U.S. Application Data
(63) Continuation-in-part of application No. 16/891,167, filed on Jun. 3, 2020.
(60) Provisional application No. 62/857,234, filed on Jun. 4, 2019.

(51) Int. Cl. A47K 3/28; H04R 1/02; A47G 23/02

(52) U.S. Cl. CPC A47K 3/281; A47G 23/0225; H04R 1/028

(57) ABSTRACT

Shown is a beverage jar holder having means that can be mounted onto a wall or placed onto a flat surface. The cup or glass is held within a cupholder-like niche, where it can be easily inserted and removed repeatedly. The cupholder contains a gap to accommodate a stem of tall glasses, so that a tall glass may be retained within the cupholder perpendicularly protruding ring, just like a cup that does not have a stem. The case of the jar holder contains a speaker and an integrated radio wave receiver. The receiver connects to a remote device which can broadcast music and other content through the speaker on the jar holder. The user can control volume and live tracks directly from the jar holder. A removable flap protects internal audio components from moisture. The audio control panel also contains a charging port for the onboard battery. The location of the charging port may differ from the control pad and the charging port may have a separate protective flap. This alternative configuration will further limit the possibility of water entry when the flap is moved out of place to adjust volume or switch soundtracks.

### CLAIM OF PRIORITY

This application claims priority to the US Provisional Utility Patent Application No. 62/857,234, which was filed on 4 Jun. 2019, the contents of which are incorporated herein by reference. This application also claims priority to the U.S. Non-Provisional Utility patent application Ser. No. 16/891,167 filed on Jun. 3, 2020, the contents of which are incorporated herein by reference.

### FIELD OF THE INVENTION

The present invention relates to a recreational accessory containing an audio component for holding beverages suspended from a support structure.

### BACKGROUND OF THE INVENTION

Bathtub and shower activities are associated with personal hygiene and, in cases of hot bath or shower, with rest and relaxation. Humans crave rest after any long or strenuous activity, or for no reason at all. Water, especially warm water, is generally associated with a release of positive endorphins, associated with happiness and relaxation.

Another form of relaxation is an occasional and moderate consumption of wine and spirits, which contain a small percentage of alcohol by volume. Moderate consumption of spirits, such as wine and beer, has shown positive social benefits, such as increased predisposition to social interaction, elevated mood and gregariousness. Moderate consumption of wine has also shown to have positive health effects, such as decreased stress level.

While bathing and consuming spirits may be treated as a relaxing or mood improving activity, music is used to stimulate a certain emotion that appeals to the listener. Because people are naturally drawn to different emotions, there are a plurality of music genre, each presenting its unique appeal to its listener.

The present invention facilitates feelings of rest and relaxation by merging the three aforementioned stimulants into a common package and thus enhancing the therapeutic appeal of the combined experience. A user who is showering or bathing may wish to remain hydrated and in a relaxed phycological predisposition by slowly consuming a favorite alcoholic beverage while listening to a sports broadcast, a podcast or to a favorite vocal artist.

The disclosed device is conveniently wrapped into a small package that removably attaches to a support surface, such as a wall of a shower or bath stall, or to a surface of a bathtub. Suction cups represent a preferred means of mounting the device onto a support surface, a, restickable adhesive means or hook and loop fasteners may work as well.

### SUMMARY OF THE INVENTION

Shown is a glass or goblet holder having the means to be mounted onto a wall and having sculpted protrusions that easily admit a tall glass or goblet and then securely hold it in place until the next draw by the user. The device is comprised of a base that is mounted onto a support surface. The base contains audio controls, radio receiver, batteries and at least one speaker. Extending from the base are contoured protrusions, which have a concave receiving area to admit a generally rounded base of a glass or goblet. The protrusions contain a gap in the middle to admit a stem of a glass.

The base of the beverage holder contains a speaker, an audio amplifier, a radio transceiver, an audio control panel and a power source. The power source may be rechargeable through a charging port within the audio control panel. The transceiver is preferably linked with a device using a radio signal, where the device would then transmit an audio signal to be amplified through the speaker of the disclosed device.

### BRIEF DESCRIPTION OF THE DRAWINGS

FIG. 1 is a perspective frontal view of the disclosed device.

FIG. 2 is a perspective frontal view of the disclosed device holding a long stem beverage container.

FIG. 3 demonstrates the internal components of the disclosed device.

FIG. 4 is a front view of the disclosed device.

FIG. 5 is the side view of the disclosed device.

FIG. 6 is a back view of the disclosed device.

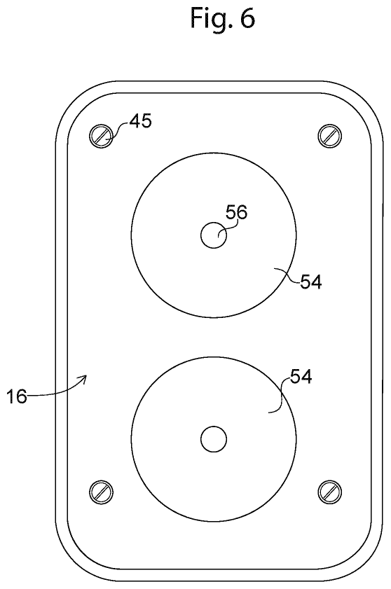

FIG. 7 is the top view of the disclosed device.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Turning now descriptively to the drawings, in which similar reference characters denote similar elements throughout the several views.

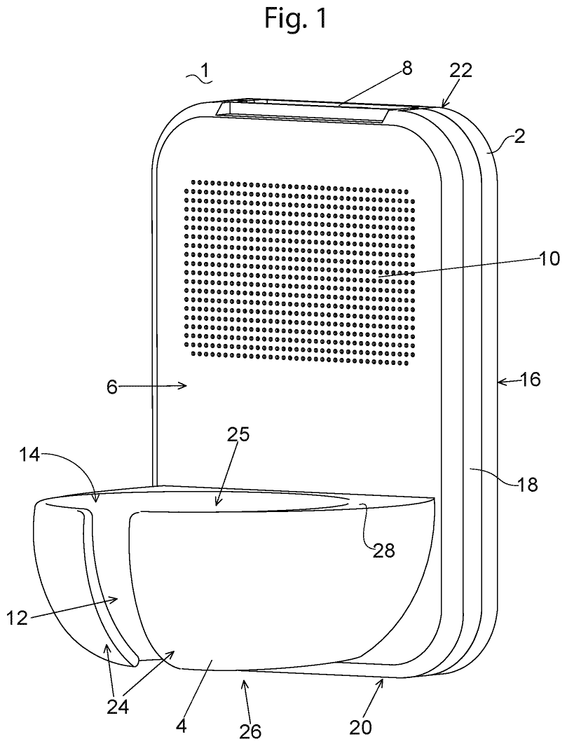

FIG. 1 demonstrates a beverage holder 1, having a base 2, cup holder 4, a front panel 6, control panel cover 8, at least one speaker 10, a gap for glass stems 12 and a cavity 14. The base 2 is preferably a rectangle having a front panel 6, a sidewall 8, a back panel 16 a top 22 and a bottom 20.

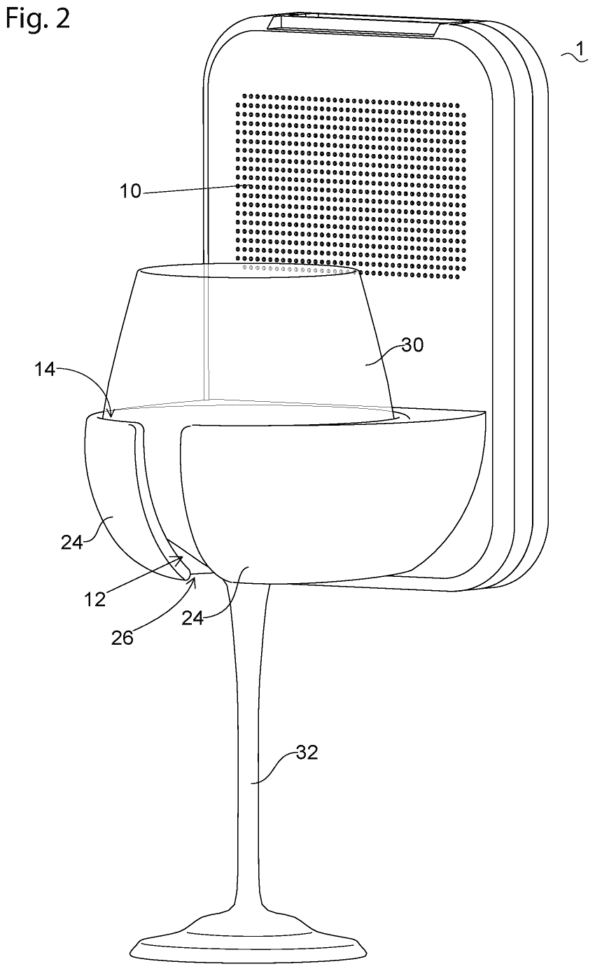

Integrated into the front panel 6 is a cup holder 4. The cup holder 4 is integrated perpendicularly with the front panel 6 has a substantially circular lip 28. The curved appendages 24 forming the cup holder 4 terminate at the gap 12. The gap 12 is used to admit a stem of a tall glass as shown in FIG. 2. The cup holder 4 forms a lop with an upper opening 25 and a lower opening 26.

FIG. 2 shows a glass 30 that is temporarily housed inside a cavity 14. The stem 32 passes through the gap 12 when the glass is placed and removed from the cavity 14. The disclosed device can offer glass holders in many settings, such as bath and shower stalls, kitchen walls and cabinet doors, upright surfaces of a vehicle's interior. In some settings a user may will to place a filled or empty glass into a cup holder 14 to participate in a social activity requiring the use of both hands or to avoid mixing the glass with many more like it on a table or countertop.

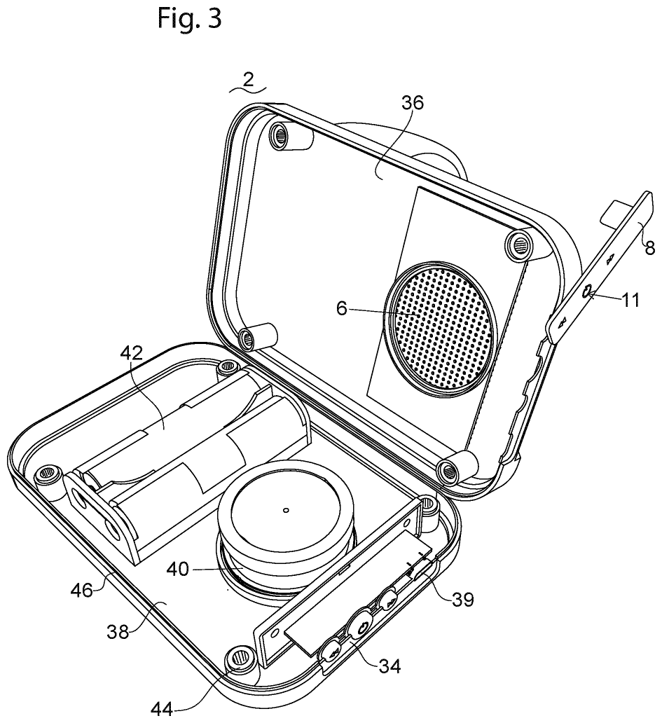

FIG. 3 demonstrates the contents of the base 2. Shown is the front lid 36, the back lid 38, the control board 34, the circuit board with integrated speaker and radio receiver 40 and an internal rechargeable battery pack 42. The internal cavity inside the base 2 is fully waterproof, having an insulating film covering the speaker port 6 and with a rubber gasket running the entire perimeter 46. The removable control panel cover 8 gives a user the ability to operate the device controls without removing the cover 8. The cover 8 needs to be removed to access the universal serial bus charging port 39. The integrated circuit 40 utilizes short wave radio signals to connect to a radio receiver in the vicinity, such as a mobile phone, tablet a tablet computer. Once connected a remote device will is able to play music utilizing the integrated speaker 40.

Fastener ports 44 are used to keep the base 6 enclosed. The fastener ports 44 may be snaped together or coupled together using screw fasteners. The width 50 of the base is preferably between 4.5 cm and 11.4 cm. The height 52 is between 7.6 and 15.2 centimeters. The height 54 of the cup holder appendage 24 is approximately between 1.2 and 3 centimeters.

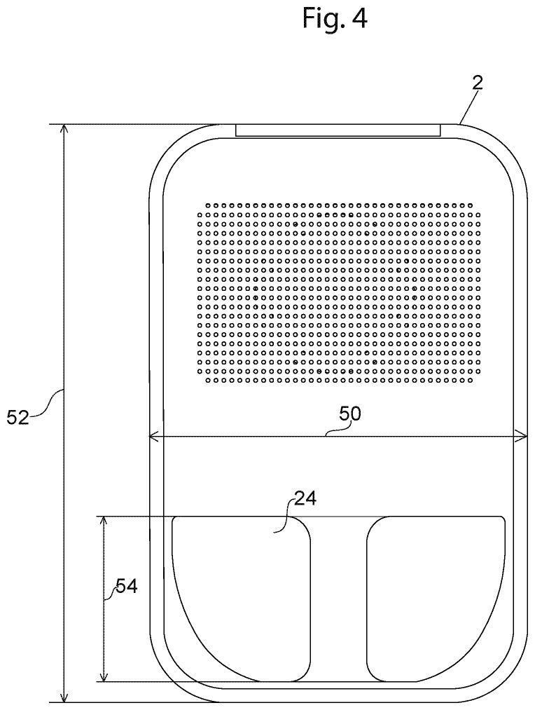

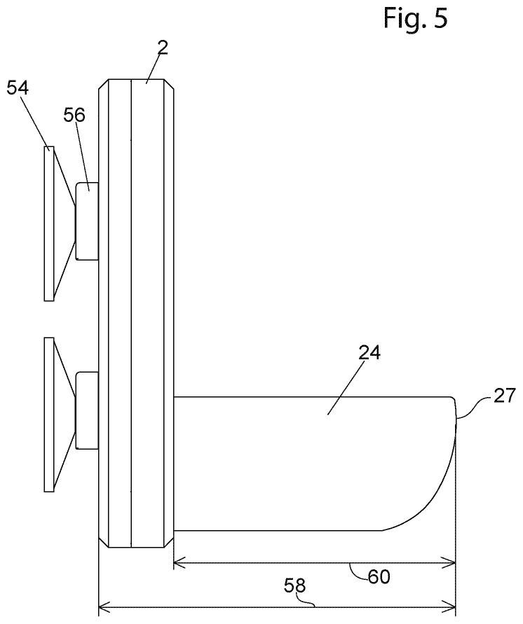

FIGS. 4 and 5 demonstrate the means by which the device may be attached to a support surface, such as a wall, door or glass pane. The means shown is a pair of suction cups 54 attached to the back wall 16 of the base 2. Fasteners 45 keep the base 2 in a closed configuration. The attachment component 56 connects the suction cups 54 with the back wall 16 of the base 2 and may also provide cautioning to muffle vibrations from the speaker 6 to be transmitted unto a support surface through the suction cups 54. An embodiment may contain one or more suction cups 54. The preferred depth 58 of the disclosed device may between 6 and 10.4 centimeters, measured from the back surface 16 until the front tip 27 of an appendage 24. The appendage 24 may have the depth 60 of approximately 4 and 8.8 centimeters. FIGS. 4 and 5 also demonstrate that the appendages 24 have an elliptical or tapered outer surface to promote a sculpted aesthetic experience but may instead have plane surfaces and straight edges instead.

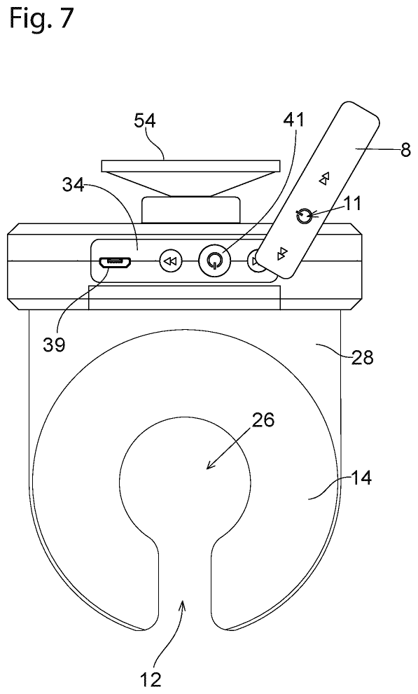

FIG. 7 is the top view of the disclosed device 1, showing a cover 8 in a disengaged position. The cover 8 contains markings to denote action areas 11 that correspond to buttons 41 of the control panel 34. The available functions of buttons 41 is power and scroll. The power button preferably has a dual function of also serving as a shortwave radio connection activator, with scroll buttons having an additional functionality of serving as volume control The power buttons may have additional operating capabilities. Furthermore, the device 1 may contain instrumentation within the base 2 to be able to receive AM or FM radio signals or even receive a satellite signal for receiving transmissions on a variety of bandwidths. A device 1 having ability to receive standard and satellite signals will contain additional controls for those features. Also shown in FIG. 7 is the bottom opening 26, the gap 12 and the top lip 28.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A beverage jar holder comprising, a corpus having a case, said case having sidewalls, a front wall and a back wall, said case incorporating a control panel, at least one speaker and connection means to connect to a remote device; a protruding ring perpendicularly emanating from said front wall, wherein said protruding ring forming a nest for holding a glass; at least one attachment means mounted along said corpus; wherein said attachment means removably mounting onto a support surface; an audio component disposed below said base capable of receiving a radio signal and amplifying said radio signal on an onboard speaker; and wherein said corpus insulating said audio component with a removable cover.

2. The beverage jar holder of claim 1, wherein said protruding ring further comprises a gap, wherein said gap capable of permitting a stem of a glass to pass therethrough.

3. The beverage jar holder of claim 1, wherein said audio component being controlled by at least two controllers within one of said sidewalls of said case.

4. The beverage jar holder of claim 1, wherein said attachment means is at least one suction cup mounted onto said back wall.

5. The beverage jar holder of claim 1, wherein said attachment means is at least one suction cup removably mounted onto said back wall.

6. The beverage jar holder of claim 1, wherein said attachment means is a plurality of suction cups attached to said back wall.

7. The beverage jar holder of claim 1, further comprising a transceiver, said transceiver receiving radio signals from a remote source and transmitting signals back to said remote source.

8. The beverage jar holder of claim 1, wherein the audio control panel further comprises a removable protective flap, a plurality of control buttons provided on an outer surface of said removable protective flap, such that a user may engage that audio control panels through said plurality of control buttons within removing said removable protective flap.
